(19) United States
(12) Patent Application Publication
(10) Pub. No.: US 2012/0079248 A1
(43) Pub. Date: Mar. 29, 2012

(54) Aliased Parameter Passing Between Microcode Callers and Microcode Subroutines

(76) Inventors: Jonathan D. Combs, Austin, TX (US); Kameswar Subramaniam, Austin, TX (US); Jason Brandt, Austin, TX (US)

(21) Appl. No.: 12/890,292

(22) Filed: Sep. 24, 2010

(51) Int. Cl. G06F 9/30; G06F 9/22

(52) U.S. Cl. 712/211; 712/E09.004

(57) ABSTRACT

An apparatus of an aspect includes a plurality of microcode alias locations and a microcode storage. A microinstruction of a microcode subroutine is stored in the microcode storage. The microinstruction has an indication of a microcode alias location. A microcode caller of the microcode subroutine is also stored in the microcode storage. The microcode caller is operable to specify a location of a parameter in the microcode alias location that is indicated by the microinstruction of the microcode subroutine. The apparatus also includes parameter location determination logic that is coupled with the microcode alias locations. The parameter location determination logic is operable, responsive to the microinstruction of the microcode subroutine, to receive the indication of the microcode alias location from the microinstruction and determine the location of the parameter specified in the microcode alias location indicated by the microinstruction.

### BACKGROUND

1. Field

Various different embodiments relate to methods, apparatus, and systems for processing instructions. In particular, various different embodiments relate to methods, apparatus, and systems for passing parameters between microcode callers and microcode subroutines.

2. Background Information

Certain processors, and other instruction execution apparatus, conventionally implement higher-level machine instructions as lower-level microinstructions. In some cases, the microinstructions or microcode may be arranged or logically divided into microcode subroutines and microcode callers. For example, the microcode callers may call the microcode subroutines to have certain operations performed within the shared microcode subroutines. In the call to the microcode subroutine, and in the return from the microcode subroutine, parameters are typically passed or communicated between the microcode callers and the microcode subroutines. The use of microcode subroutines may offer various potential advantages, such as, for example, the ability to reduce the amount of microcode that needs to be stored. However, the uses and benefits of microcode subroutines are limited by certain aspects.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of an embodiment of a processor having an embodiment of a microcode aliased parameter passing logic.

FIG. 2 is a block flow diagram of an embodiment of a method of passing parameters between a microcode caller and a microcode subroutine.

FIG. 3 is a block diagram of an embodiment of microcode aliased parameter passing logic.

FIG. 4 is a block diagram of an example embodiment of a microcode aliased parameter passing logic having a particular example embodiment of a microcode alias register and particular example embodiment of parameter location determination logic.

FIG. 5 is a block diagram of a particular example embodiment of a 16-bit microcode alias register.

FIG. 6 is a block diagram of an example embodiment of a microcode aliased parameter passing logic having a particular example embodiment of a microcode alias register and a particular example embodiment of parameter location determination logic to determine locations of a first source, a second source, and a result.

FIG. 7 is a block flow diagram of an embodiment of a method of saving or preserving values from microcode alias locations.

FIG. 8 is a block diagram of an embodiment of microcode aliased parameter value save logic.

FIG. 9 is a block diagram of an example embodiment of microcode aliased parameter value save logic having a particular example embodiment of a microcode alias register and particular example embodiment of save logic.

FIG. 10 is a block diagram of a particular example embodiment of a suitable destination storage location.

FIG. 11 is a block diagram of an embodiment of microcode aliased parameter value restore logic.

FIG. 12 is a block diagram of an example embodiment of a suitable computer system or electronic device.

### DETAILED DESCRIPTION

In the following description, numerous specific details, such as particular processor components and configurations, particular register sizes, particular types of parameters, and the like, are set forth. However, it is understood that embodiments of the invention may be practiced without these specific details. In other instances, well-known circuits, structures and techniques have not been shown in detail in order not to obscure the understanding of this description.

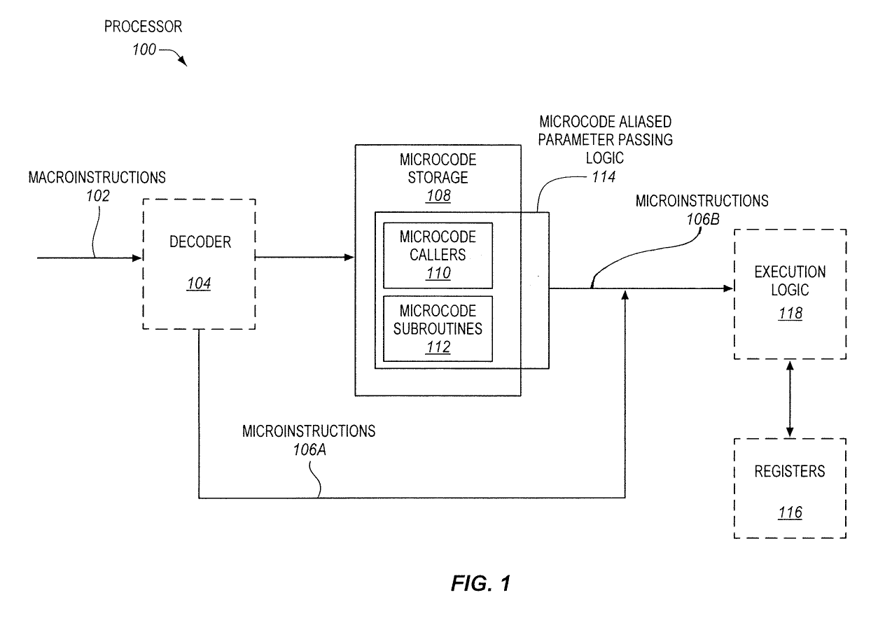

FIG. 1 is a block diagram of an embodiment of a processor 100 having an embodiment of a microcode aliased parameter passing logic 114. The processor may be any of various complex instruction set computing (CISC) processors, various reduced instruction set computing (RISC) processors, various very long instruction word (VLIW) processors, various hybrids thereof, or other types of processors.

In one or more embodiments, the processor may be a general-purpose processor, such as, for example, one of the general-purpose processors manufactured by Intel Corporation, of Santa Clara, Calif., although this is not required. A few representative examples of suitable general-purpose processors available from Intel Corporation include, but are not limited to, Intel® Atom™ Processors, Intel® Core™ processors, Intel® Core™2 processors, Intel® Pentium® processors, and Intel® Celeron® processors.

Alternatively, the processor may be a special-purpose processor. Representative examples of suitable special-purpose processors include, but are not limited to, network processors, communications processors, cryptographic processors, graphics processors, co-processors, embedded processors, and digital signal processors (DSPs), to name just a few examples. These processors can also be based on CISC, RISC, VLIW, hybrids thereof, or other types of processors. In still other embodiments, the processor or instruction processing apparatus may represent a controller (e.g., a microcontroller), or other type of logic circuit capable of processing microcode or microinstructions.

The processor includes a decoder 104. The decoder may receive and decode higher-level machine instructions or macroinstructions 102. The decoder may generate and output one or more lower-level microinstructions 106A based on or derived from the macroinstructions. The microinstructions output from the decoder may represent micro-operations, micro-ops, μops, micro-code entry points, or other microinstructions. The microinstructions may implement the operations of the higher-level or machine-level instructions through lower-level (e.g., circuit-level or hardware-level) operations. The processor or apparatus may have particular circuitry responsive to the microinstructions.

The decoder may be implemented using various different types of mechanisms. Examples of suitable types of mechanisms include, but are not limited to, microcode read only memories (ROMs), look-up tables, hardware implementations, programmable logic arrays (PLAs), and the like. In some cases, the decoder may represent, or be replaced or supplemented by, an instruction emulator, an instruction translator, an instruction morpher, an instruction interpreter, or other instruction conversion logic. Various different types of instruction emulators, instruction morphers, instruction translators, and the like, are known in the arts. The decoder or other instruction conversion logic may be implemented in hardware (e.g., circuitry), firmware, software, or a combination thereof.

Referring again to FIG. 1, the processor also includes a microcode storage 108. The microcode storage stores microcode, or groups or sequences of microinstructions. The decoder may provide certain instructions to the microcode storage and the microcode storage may further decode these instructions into microinstructions 106B. As further shown, in one or more embodiments, the microcode in the microcode storage may include, or be logically divided into, microcode callers 110 and microcode subroutines 112. The microcode callers may call the microcode subroutines to have certain operations performed within the microcode subroutines. The microcode subroutines may perform the operations and return to the microcode caller. Alternatively, the microcode subroutine may represent a shared microcode routine that is shared by multiple callers, but does not necessarily return to the microcode caller.

One potential advantage of using the microcode callers and subroutines is that it may help to reduce the overall size of the microcode. For example, microcode for operations (e.g., commonly performed operations) may be placed in a shared subroutine, which may be called each time those operations need to be performed. This may help to avoid replicating or duplicating the microcode for these operations at each location where the operations associated with the microcode subroutine need to be performed. Reducing the amount of microcode may help to reduce the amount of memory or storage needed to store the microcode, which may potentially help to reduce the size, cost, and power consumption of the processor.

Another potential advantage to using microcode subroutines is a reduction in the amount of code that needs to be debugged and/or validated. For example, the microcode of the microcode subroutine may only need to be debugged and validated once, whereas if the microcode subroutine did not exist, multiple copies of the microcode, for example one at each location where the operations associated with the microcode subroutine need to be performed, may need to be debugged and validated. Reducing the amount of microcode that needs to be debugged and validated may also help to reduce the time and cost of providing the microcode.

However, conventionally the use and benefit of microcode subroutines has been limited. One significant factor is the lack of a flexible way of passing parameters between the microcode callers and the microcode subroutines in the call and in some cases the return if there is a return. For example, the microcode subroutine may expect a parameter (e.g., an input value to be operated on) to be in a fixed or static location (e.g., a fixed or static register assigned for that parameter), and the microcode caller (or all microcode callers of that microcode subroutine), may be forced to use that fixed or static location. The microcode caller may need to ensure that the parameter is actually located in that fixed or static location. For example, if the microcode subroutine needs to have a first input parameter in a first fixed register (e.g. Register1) and a second input parameter in a second fixed register (e.g., Register2) and needs to store a result in a third fixed register (e.g., Register3), then every microcode caller of the microcode subroutine may need to ensure that the first input parameter is in the first fixed register (Register1), that the second input parameter is in the second fixed register (Register2), and may need to get the result from the third fixed register (Register3).

When the input parameters are not initially located in the fixed or static locations expected by the microcode subroutine, the microcode caller may need to rearrange input parameters from the initial locations to the expected fixed or static locations, prior to calling the microcode subroutine. This may involve performing additional rearrangement operations, for example, to move or copy the parameters from the initial locations to the final locations. Such additional rearrangement operations may tend to reduce the performance of the microcode and/or increase the overall amount of microcode. Moreover, sometimes it may not be possible or practical for the microcode caller to rearrange the values in the registers, for example if a value in a fixed or static register needed by the microcode subroutine is needed by another instruction and cannot be consumed by moving or copying a value to that register, in which case it may not be possible or practical to utilize the microcode subroutine.

Referring again to FIG. 1, in one or more embodiments, the processor may have the microcode aliased parameter passing logic 114. The microcode aliased parameter passing logic may be logically disposed or coupled between the decoder and the execution logic. The microcode aliased parameter passing logic may use aliasing to allow parameters to be flexibly passed or communicated between the microcode callers and the microcode subroutines. For example, in one or more embodiments, the microcode aliased parameter passing logic may allow microcode callers to flexibly specify registers or other locations of parameters in microcode alias locations so that the parameters do not have to be located in fixed or static registers expected by the microcode subroutines. The microcode aliased parameter passing logic may be implemented in hardware (e.g., circuitry), software, firmware, or a combination thereof. In one aspect, the microcode aliased parameter passing logic includes at least some circuitry. The circuitry may be particular circuitry responsive to microinstructions.

The processor also includes a plurality of registers 116 and execution logic 118. The execution logic may include one or more execution cores each having one or more execution units. In one aspect, the execution units may include at least some hardware (e.g., circuitry). The microinstructions from the microcode storage may be executed by the execution logic, with source data potentially being accessed from, and results potentially being stored in, the registers. The decoder, the execution logic, and the registers, are shown in dashed lines to indicate that they are not required components of embodiments of the invention.

To avoid obscuring the description, a relatively simplistic processor has been shown and described. It will be appreciated that the processor may optionally include one or more other well-known components, such as, for example, one or more of instruction fetch logic, branch prediction logic, instruction and data caches, instruction and data translation lookaside buffers, prefetch buffers, microinstruction queues, microinstruction sequencers, bus interface units, second or higher level caches, instruction scheduling logic, retirement logic, register renaming logic, and the like, and various combinations thereof. There are literally numerous different possible combinations and configurations of such components known in the arts, and the scope of the invention is not limited to any such combination or configuration. Moreover, these components, if present, may either be convention, or substantially conventional perhaps with minor adaptations that would be apparent to those skilled in the art based on the present disclosure. Further description of these components is not needed in order to understand the embodiments herein, although further description is readily available, if desired, in the public literature.

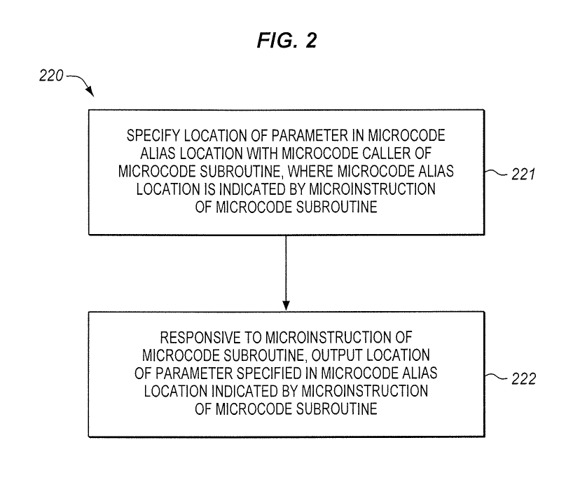

FIG. 2 is a block flow diagram of an embodiment of a method 220 of passing parameters between a microcode caller and a microcode subroutine. In one or more embodiments, the method may be performed by and/or within a processor or other instruction processing apparatus. For example, in one or more embodiments, the method may be performed by and/or within the processor 100 of FIG. 1, or one similar. Alternatively, the method 220 may be performed by and/or within a processor or other instruction processing apparatus entirely different than the processor of FIG. 1.

The method includes a microcode caller of a microcode subroutine specifying a location of a parameter in a microcode alias location indicated by a microinstruction of the microcode subroutine, at block 221. By way of example, in one or more embodiments, the microcode caller may have at least one of a microinstruction and a flowmarker to specify the location of the parameter, for example by writing a value representing a particular register where the parameter is stored, in the microcode alias location. By way of example, in one or more embodiments, the location of the parameter may be a location of a source data or a location where a result is to be stored.

Referring again to FIG. 2, the method also includes, responsive to the microinstruction of the microcode subroutine, determining and outputting the location of the parameter specified in the microcode alias location indicated by the microinstruction of the microcode subroutine, at block 222. In one or more embodiments, the microinstruction of the microcode subroutine may indicate the microcode alias location as a fixed or static microcode alias location for that particular microinstruction and for that particular parameter. In one or more embodiments, the microcode caller may dynamically map or associate a flexible location (e.g., a location that is any one of several possible acceptable locations) of that particular parameter with the fixed or static microcode alias location pointed to or indicated by the microinstruction.

This may provide a flexible approach for passing parameters between microcode callers and microcode subroutines. Rather than a microcode caller having to ensure that a parameter is actually located in a fixed or static register expected by a microinstruction of a microcode subroutine, and move or copy the parameter if it is not initially located in that fixed or static register, the microcode caller may instead dynamically specify a flexible location of the parameter in a fixed or static microcode alias location, pointed to or indicated by the microinstruction. Advantageously, this may help to avoid the need to move, copy, or otherwise rearrange the location of the parameter, which may help to improve performance by eliminating operations and/or may help to reduce the total amount of microcode, which may potentially reduce the cost, size, and power consumption of the processor.

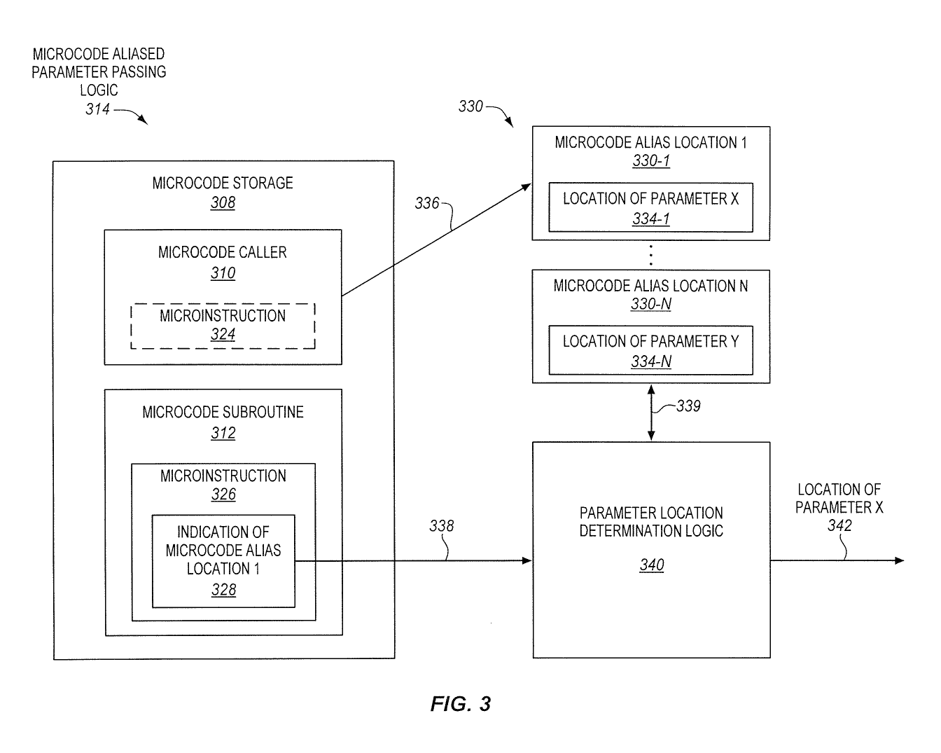

FIG. 3 is a block diagram of an embodiment of microcode aliased parameter passing logic 314. In one or more embodiments, the logic 314 may be included in the processor 100 of FIG. 1, or one similar, or an entirely different instruction processing apparatus. In one or more embodiments, the logic 314 may perform the method of FIG. 2, or one similar. However, it is to be understood that the logic 314 may perform operations and methods different than those shown in FIG. 2. Moreover, the operations or method discussed above for FIG. 2 may be performed by microcode aliased parameter passing logic either the same as, or similar to, or entirely different than, the logic 314.

Referring again to FIG. 3, the microcode aliased parameter passing logic includes a microcode storage 308. The microcode storage may represent a memory or storage device that is operable to store, or that stores, microcode. The microcode storage may be implemented with various different types of memory or storage devices. Examples of suitable types of memory or storage devices include, but are not limited to, read only memories (ROMs), programmable logic arrays (PLAs), static random access memories (SRAMs), and flash memories. In one or more embodiments, the microcode storage may be implemented with ROM, the scope of the invention is not limited in this respect. Microinstructions of the microcode may be accessed from the microcode storage, for example by a microsequencer (not shown), which may generate addresses to step through the microcode in the microcode storage.

As shown in FIG. 3, the microcode storage is operable to store, or stores, a microcode caller 310 and a microcode subroutine 312. The microcode caller is to be interpreted broadly as a portion of the microcode that is operable to call the microcode subroutine. For example, the microcode caller may have a microinstruction, flowmarker, or other logic or portion of the microcode that is operable to call the microcode subroutine. The microcode caller may include more than just the microinstruction or flowmarker that calls the microcode subroutine. The microcode subroutine is to be interpreted broadly as a portion of the microcode that is operable to be called by the microcode caller. In embodiments, the microcode subroutine may return to the microcode caller. Alternatively, in another embodiment, the microcode subroutine may represent a shared microcode routine that is shared by multiple callers, but may not necessarily return to the microcode caller. The microcode of the caller and/or subroutine may include one or more microinstructions that are to be executed on specific or particular circuitry or other logic (e.g., software combined with hardware and/or firmware) of the processor. To simplify the illustration and the description, only a single microcode caller and a single microcode subroutine are shown, although it is to be appreciated that there may be a plurality of each, including potentially multiple microcode callers of the same shared microcode subroutine.

The microcode aliased parameter passing logic also includes a plurality of microcode alias locations 330. In the illustrated embodiment, the microcode alias locations include a first microcode alias location 330-1, and an Nth microcode alias location 330-N, where the number N represents a positive integer number, typically ranging from two to about ten. In one particular example embodiment, the number of microcode alias locations (N) may be four, although the scope of the invention is not limited in this respect. Alternatively, there may be only one microcode alias location.

In one or more embodiments, each of the microcode alias locations 330 is operable to store or represent a value (e.g., an integer number). In various example embodiments, the microcode alias locations may be different locations in the same register, different locations in different registers, different discrete dedicated storage locations, different locations in a table, different locations in a data structure, or a combination thereof, to name just a few examples. In one particular example embodiment, the microcode alias locations may represent different locations in a common microcode alias register, although the scope of the invention is not limited in this respect.

The microcode subroutine includes a given microinstruction 326. The given microinstruction 326 may be of various different types, such as an add microinstruction, an exclusive OR microinstruction, a load microinstruction, etc. The microinstruction has or includes an indication 328 of a microcode alias location of the plurality. In the particular example of the illustration, the indication 328 of the microinstruction 326 points to or indicates the first microcode alias location 330-1, although this is merely for purposes of illustration of this example, and is not required. The indication may either be implicit to the microinstruction, or the indication may be explicitly specified by the microinstruction (e.g., through a field of bit values). In one or more embodiments, the indication 328 of the microcode alias location may be fixed or static for a particular corresponding parameter for the particular given microinstruction 326. In other words, the microinstruction 326 may need or expect to find the location of the particular corresponding parameter in the fixed or static microcode alias location pointed to by the indication 328. Likewise, multiple microinstructions, or potentially each microinstruction in the microcode subroutine, may indicate microcode alias register locations where the locations of parameters are expected.

The microcode caller 310 is operable to write or otherwise specify a location of the particular corresponding parameter in the microcode alias location that is pointed to or indicated by the indication 328 of the microinstruction 326 (e.g., in this example the microcode alias location 1 330-1). In one or more embodiments, the microcode caller may include a dedicated microinstruction (e.g., a write microinstruction), a flowmarker, a flowmarker attached to a microinstruction, or another portion of the microcode caller, to write or otherwise specify the location of the parameter in the microcode alias location. The flowmarker or microinstruction that specifies the location does not have to be the same flowmarker or microinstruction that calls the microcode subroutine. Commonly the locations should be specified in the microcode alias locations before the microcode subroutine accesses them. However, the locations may be specified in the microcode alias locations before the actual microinstruction or flowmarker performs the call to the microcode subroutine, for example anywhere from several to many microinstructions before the call microinstruction. Or the locations may be specified in the call microinstruction itself. The processor may have a circuit or other hardware to perform the write responsive to the microinstruction or flowmarker. In one or more embodiments, the location of the parameter may be a value indicating a register or other storage location where the parameter is stored. For example, in one or more embodiments, the location of the parameter specified in the microcode alias location may be an integer number, where the integer number represents a register number specifying a particular register where the parameter is stored. The register storing the parameter may be an integer register, floating point register, segment register, or control register, for example, depending on the context of the operation being performed and/or depending on the microinstruction.

In one or more embodiments, it may be known or understood in advance of the microcode caller specifying the location of the parameter in the microcode alias location (in this example the microcode alias location 1 330-1) that the microinstruction 326 includes the indication 328 of that particular microcode alias location (in this example the microcode alias location 1 330-1) for the corresponding parameter. For example, a micro-programmer may know that the microinstruction 326 includes the indication 330 of the microcode alias location (in this example the microcode alias location 1 330-1) corresponding to the particular parameter, and the micro-programmer may program the microcode caller to write the location of the particular parameter in this indicated microcode alias location (in this example the microcode alias location 1 330-1).

In one or more embodiments, this may allow the microcode caller to dynamically map or associate a flexible location (e.g., a location that is any one of several possible acceptable locations) of the particular parameter with the fixed or static microcode alias location pointed to by the indication 328 of the microinstruction 326. Advantageously, this may help to avoid the need for the microcode caller to move the particular parameter from an initial register location to a fixed or static register location expected by the microinstruction of the microcode subroutine.

Various different types of parameters are suitable. The parameter may represent a parameter that is passed between the microcode caller and the microcode subroutine. Examples of suitable parameters include, but are not limited to, one or more source data (e.g., a first source data and a second source data), one or more results, one or more immediate data, a parameter specifying a type of microoperation to be performed (e.g., whether an addition or a subtraction type of operation is to be performed), a parameter specifying a mode in which a particular microoperation is to be performed (e.g., whether or not an operation is to be performed with saturation, rounding, etc.), a parameter specifying a mode or way in which one or more arithmetic flags are to be used (e.g., whether or not addition is to be performed with carry, overflow, etc.), and combinations thereof, to name just a few examples. In one or more particular example embodiments, the parameter may be one of a first source data, a second source data, and a result, or a combination thereof, although the scope of the invention is not limited in this respect.

Referring again to FIG. 3, the microcode aliased parameter passing logic also includes parameter location determination logic 340. The parameter location determination logic may include hardware, software, firmware, or a combination thereof. In one or more embodiments, the parameter location determination logic may include at least some circuitry. The parameter location determination logic is coupled with the plurality of microcode alias locations 330.

The parameter location determination logic is responsive to the microinstruction 326 of the subroutine 312, to receive the indication 328 of the microcode alias location from the microinstruction 326 (in this example indicating the first microcode alias location 330-1). The microcode caller 310 has specified a location 334-1 of a parameter in the microcode alias location corresponding to the indication 328 (which in this example is the first microcode alias location 330-1). The parameter location determination logic is operable to determine the location 334-1 of the parameter specified in the microcode alias location that is pointed to or indicated by or that corresponds to the indication 328 (which in this example is the first microcode alias location 330-1).

The parameter location determination logic may output the determined location 342 of the parameter. By way of example, the determined location of the parameter may be passed down the pipeline, for example to or toward execution logic (e.g., one or more execution cores) or other back end logic. In one aspect, the locations of the parameters may be written or specified in one cycle and output the next cycle with no additional serialization required between the subroutine caller (the microcode alias location writer) and the microcode subroutine (the microcode alias location reader). Without limitation, the execution logic may execute the operation(s) associated with the microinstruction on or according to the parameter located in the now resolved location of the parameter.

Advantageously, the microcode aliased parameter passing logic may provide a flexible mechanism for passing the parameter between the microcode caller and the microcode subroutine. Instead of the microcode caller having to ensure that the parameter is located in a fixed or static register expected by the microinstruction of the microcode subroutine, and move or copy the parameter if it is not initially located in that fixed or static register, the microcode caller may instead specify a flexible location of the parameter in a fixed or static microcode alias location pointed to by the indication of the microinstruction. Advantageously, this may help to avoid the need to move, copy, or otherwise rearrange the location of the parameter, which may help to improve performance by eliminating operations and may help to reduce the total amount of microcode, which may reduce the cost and power consumption of the processor. Also, different microcode callers of the same shared microcode subroutine may optionally specify different locations for the same particular parameter for the same particular microinstruction of the microcode subroutine.

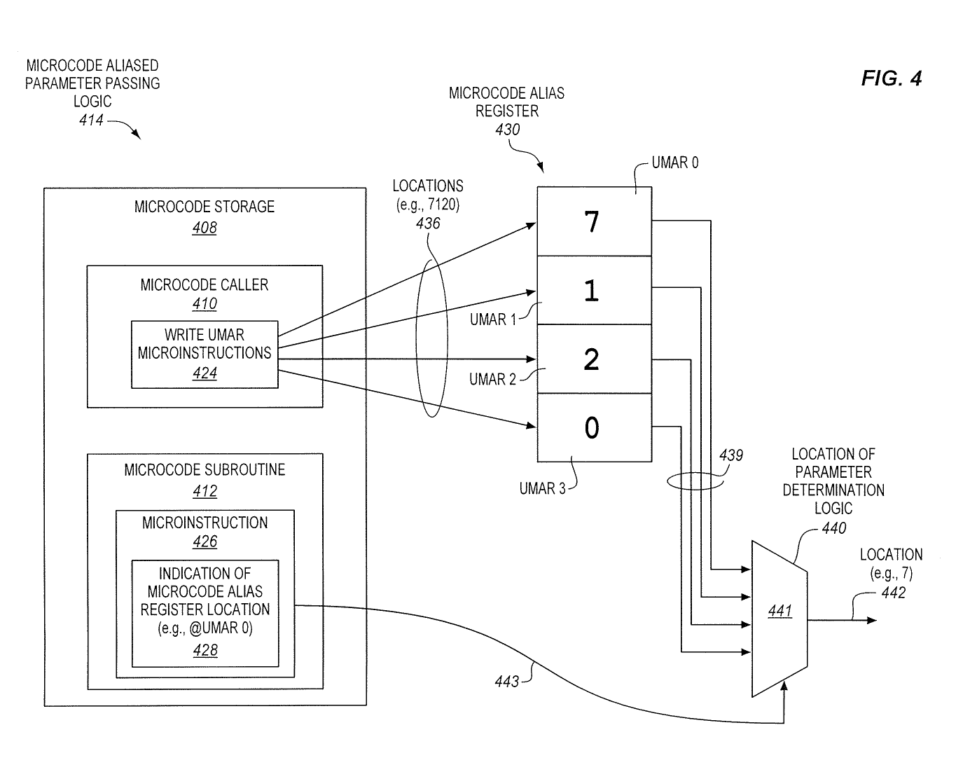

FIG. 4 is a block diagram of an example embodiment of a microcode aliased parameter passing logic 414 having a particular example embodiment of a microcode alias register (UMAR) 430 and particular example embodiment of parameter location determination logic 440. It is to be understood that the example microcode aliased parameter passing logic 414, including the particular microcode alias register 430 and the particular parameter location determination logic 440, are merely examples and are not required.

The microcode aliased parameter passing logic also includes a microcode storage 408, a microcode caller 410, a microcode subroutine 412, and a microinstruction 426 of the microcode subroutine. The microcode storage 408, the microcode caller 410, the microcode subroutine 412, and the microinstruction 426 may optionally be similar to, or the same as, the correspondingly named components of the logic 314 of FIG. 3. To avoid obscuring the description, all of these similarities will not be unnecessarily repeated, but rather the discussion below will tend to focus on the different and/or additional characteristics of the logic 414 of FIG. 4.

The microcode alias register (UMAR) 430 represents one example embodiment of a plurality of microcode alias locations. The microcode alias register has a plurality of microcode alias register locations. As shown in the illustrated example embodiment, the microcode alias register has four microcode alias register locations, in the illustration labeled as UMAR0, UMAR1, UMAR2, and UMAR3, although the scope of the invention is not limited to just four locations.

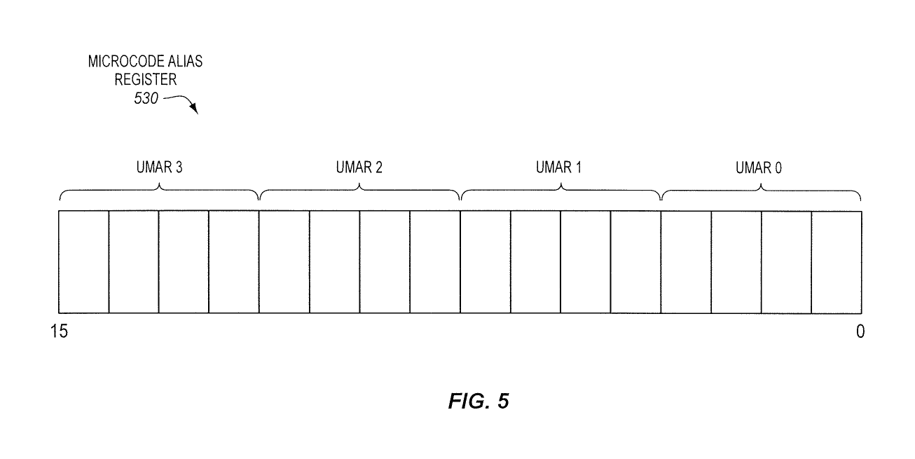

FIG. 5 is a block diagram of a particular example embodiment of a 16-bit microcode alias register (UMAR) 530. The UMAR has 16-bits which may be logically divided into up to four groups of four contiguous bits. Each of the four, 4-bit groups may be used to store a value representing a location of a parameter. As shown, in one example, bits 3:0 may be used to store UMAR0, bits 7:4 may be used to store UMAR1, bits 11:8 may be used to store UMAR2, bits 15:12 may be used to store UMAR3. In one or more embodiments, the values stored in the UMAR may refer to locations in the integer, floating point, or segment register file depending on the context of the operation being performed. This is just one example embodiment of an UMAR, and the scope of the invention is not limited to this particular example UMAR. In alternate embodiments, either fewer or more locations, each having either fewer or more bits for each location, including not necessarily the same number of bits for each location, are also suitable.

Referring again to FIG. 4, the microinstruction 426 of the microcode subroutine has an indication 428 of a microcode alias register location (which in this example is UMAR0). For example, the indication may be @UMAR0, where the symbol @ indicates an aliased location. The microcode caller of the microcode subroutine is operable to write or otherwise specify a location of a parameter in the microcode alias register location indicated by the microinstruction of the microcode subroutine. As shown, in one or more embodiments, the microcode caller may include a write microinstruction 424 to write or specify the location. Alternatively, instead of the write microinstruction, a flowmarker, a flowmarker attached to a microinstruction, or other portion of the microcode caller may write or specify the location.

Optionally, the write microinstruction may write multiple locations 436 in the microcode alias register locations. For example, as shown, the write microinstruction may write the integer values 7, 1, 2, and 0 in the four microcode alias register locations UMAR0, UMAR1, UMAR2, and UMAR3, respectively. The integer values 7, 1, 2, and 0 are merely examples for purposes of illustration. Each of these integer values (i.e., 7, 1, 2, 0) may represent a register number or other location where a different corresponding parameter is stored (e.g., Register7, Register1, Register2, and Register0). In one or more embodiments, the values or locations may be written with values from an immediate field of the microinstruction and/or the microcode caller.

The parameter location determination logic 440 is coupled with the microcode alias register 430. The parameter location determination logic is operable, responsive to the microinstruction 426 of the microcode subroutine, to receive the indication 428 of the microcode alias register location from the microinstruction. The parameter location determination logic is operable to determine the location 436 of the parameter specified in the microcode alias register location pointed to by the indication 428 of the microinstruction 426 (which in this particular example is @UMAR0).

The example parameter location determination logic in the illustration includes a multiplexer (MUX) 441. The MUX represents one suitable selection circuit or selection logic, although other selection circuits, selection logic, or substitutes for the MUX known in the arts are also suitable. The MUX is coupled to receive as inputs the output of each of the microcode alias register locations. For example, as shown lines or paths 439 may couple outputs of each of UMAR0, UMAR1, UMAR2, and UMAR3 with corresponding inputs to the MUX. The MUX is also coupled by a line or path 443 to receive as a control input the indication 428 of the microcode alias register location of the microinstruction. The MUX is operable to select or determine one of the inputs corresponding to, indicated by, or based on, the indication 428 or control input.

As one example, if the indication 428 of the microcode alias register location is @UMAR0, where the symbol @ designates an alias, then the MUX may select or determine the integer value 7 which in this example is stored or represented in UMAR0. The MUX may output the integer value 7 at an output thereof. The integer value 7 may represent a location of the corresponding parameter associated with the indication 428. By way of example, the integer value 7 may represent Register7 where the parameter is stored. Accordingly, the indication @UMAR0 of the microinstruction 426 may be transformed via the microcode alias register and the parameter location determination logic to the integer value 7 indicating Register7 where the parameter corresponding to the indication is stored.

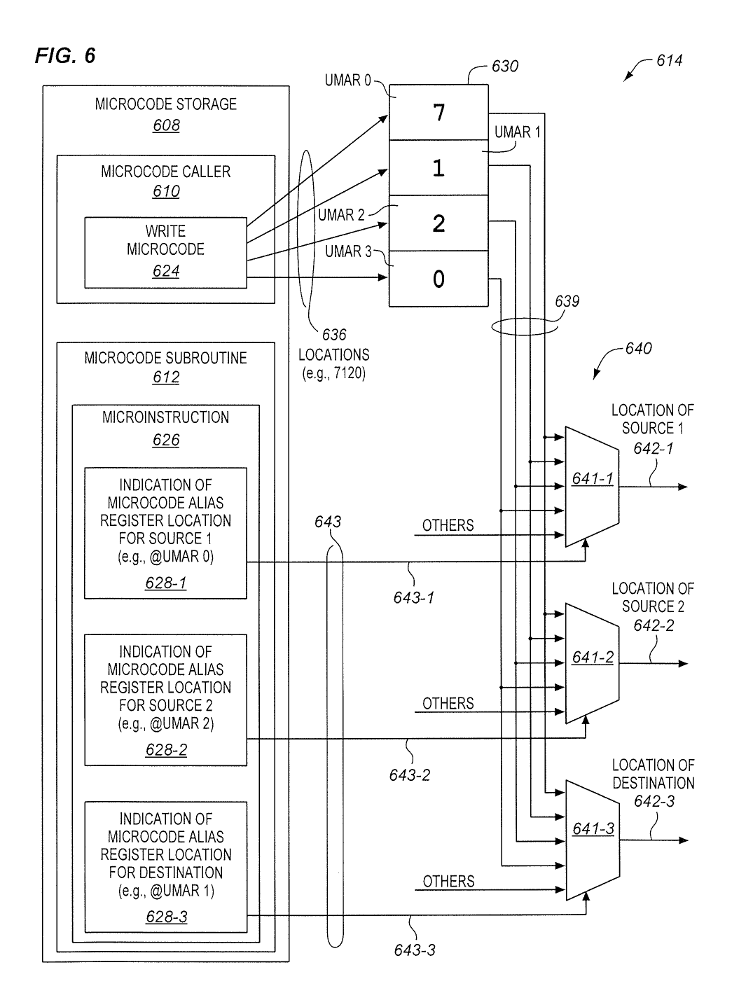

FIG. 6 is a block diagram of an example embodiment of a microcode aliased parameter passing logic 614 having a particular example embodiment of a microcode alias register (UMAR) 630 and a particular example embodiment of parameter location determination logic 640 to determine locations of a first source, a second source, and a result. It is to be understood that the example microcode aliased parameter passing logic 614, including the particular microcode alias register 630 and the particular parameter location determination logic 640, are merely examples and are not required.

The microcode aliased parameter passing logic also includes a microcode storage 608, a microcode caller 610, and a microcode subroutine 612. The microcode storage 608, the microcode caller 610, and the microcode subroutine 612 may optionally be similar to, or the same as, the correspondingly named components of the logics of FIG. 3 or 4. To avoid obscuring the description, all of these similarities will not be unnecessarily repeated, but rather the discussion below will tend to focus on the different and/or additional characteristics of the logic 614 of FIG. 6.

The illustrated microcode alias register (UMAR) has four microcode alias register locations, labeled UMAR0, UMAR1, UMAR2, and UMAR3, although the scope of the invention is not limited to just four locations. Instead of the microcode alias register (UMAR) other microcode alias locations disclosed herein may alternatively be used.

A microinstruction 626 of the microcode subroutine has a first indication 628-1 of a first microcode alias register location corresponding to a first source used by the microinstruction 626, a second indication 628-2 of a second microcode alias register location corresponding to a second source used by the microinstruction 626, and a third indication 628-3 of a third microcode alias register location corresponding to a result used by the microinstruction 626. In some cases, the same microcode alias register location may be indicated for both a source and a result.

The microcode caller of the microcode subroutine is operable to write or otherwise specify locations of the first source, the second source, and the result in the microcode alias register locations indicated by the indications 628 of the microinstruction. The microcode caller may specify a first location (e.g., a value representing a first register) of the first source in the first microcode alias register location indicated by the microinstruction, specify a second location of the second source in the second microcode alias register location indicated by the microinstruction, and specify a third location for the result in the third microcode alias register location indicated by the microinstruction of the subroutine.

As shown, in one or more embodiments, the microcode caller may include a write microinstruction 624 to write or specify these locations. Alternatively, instead of the write microinstruction, a flowmarker, a flowmarker attached to a microinstruction, or other portion of the microcode caller may write or specify the locations. By way of example, as shown, the write microinstruction may write the integer values 7, 1, 2, and 0 in the four microcode alias register locations UMAR0, UMAR1, UMAR2, and UMAR3, respectively. Each of these integer values (i.e., 7, 1, 2, 0) may represent a register number or other location where a different corresponding parameter is stored (e.g., Register7, Register1, Register2, and Register0).

The parameter location determination logic 640 is coupled with the microcode alias register 630. The parameter location determination logic is operable, responsive to the microinstruction 626 of the microcode subroutine, to receive the first indication 628-1 of one of the microcode alias register locations corresponding to the first source (e.g., @UMAR0), the second indication 628-2 of one of the microcode alias register locations corresponding to the second source (e.g., @UMAR2), and the third indication 628-3 of one of the microcode alias register locations corresponding to the result (e.g., @UMAR1).

The example parameter location determination logic for each of the first source, the second source, and the result in the example embodiment includes a multiplexer (MUX) 641, although other selection circuits, selection logic, or substitutes for the MUX known in the arts are also suitable. Each of the MUXs is coupled to receive as inputs the output of each of the microcode alias register locations. For example, as shown lines or paths 639 may couple outputs of each of UMAR0, UMAR1, UMAR2, and UMAR3 with corresponding inputs of each of the three MUXs. Other inputs not pertinent to this disclosure may also optionally be provided to the MUX, for example those pertaining to different fields of variable length instructions. Each of the MUXs is also coupled by a separate line or path 643 to receive as a control input a corresponding one of the indications 628 of a microcode alias register location for a corresponding one of the parameters. For example, the upper MUX 641-1 is coupled to receive as a control input the first indication 643-1 corresponding to the first source, the middle MUX 641-2 is coupled to receive as a control input the second indication 643-2 corresponding to the second source, and the bottom MUX 641-3 is coupled to receive as a control input the third indication 643-3 corresponding to the result. Each of the MUXs is operable to select or determine one of the inputs from the microcode alias register corresponding to, indicated by, or based on, the indication or control input provided to that particular MUX.

As one example, if the microinstruction of the microcode subroutine is of the form result=first source+second source, and has the particular indications @UMAR1=@UMAR0+@UMAR2, where each symbol @ designates an alias, then the upper MUX 641-1 may select or determine the integer value 7 which in this example is stored or represented in UMAR0, the middle MUX 641-2 may select or determine the integer value 2 which in this example is stored or represented in UMAR2, and the lower MUX 641-3 may select or determine the integer value 1 which in this example is stored or represented in UMAR1. By way of example, the integer value 7 may represent Register7 where the first source data is stored, the integer value 2 may represent Register2 where the second source data is stored, and the integer value 1 may represent Register1 where the result generated by the microinstruction is to be stored. Continuing with this example, the aliased indications of the microinstruction @UMAR1=@UMAR0+@UMAR2 may be transformed via the microcode alias register and the parameter location determination logic to Register1=Register7+Register2.

Certain processors utilize speculative execution. Speculative execution generally refers to the execution of code speculatively before it is definitively known that the execution of the code is needed. One area that speculative execution is commonly used is with branch prediction. Branch prediction involves predicting the direction of a branch, for example the direction of microbranch of a conditional branch microinstruction, before the correct direction of the branch is definitively known. For example, the processor may make an educated guess about what direction the conditional branch instruction is most likely to take based on past history. The processor may then start executing instructions speculatively based on the assumption that the predicted branch direction is correct, but before the processor knows whether or not the predicted branch direction is actually correct.

The predicted branch direction will later turn out either to be correct or incorrect. If the predicted branch direction later turns out to be correct, then the results of the speculative execution may be utilized. In this case, the speculative execution offers value in greater utilization of pipeline stages that would otherwise have been dormant or at least underutilized while waiting for the correct direction of the branch direction to be known. Alternatively, if the predicted branch direction turns out to be incorrect, or the branch direction was mispredicted, then the speculatively execution past the conditional branch instruction typically should be discarded, and the execution typically should be rewound by jumping or branching back in the control flow to the conditional branch that was mispredicted. The control flow may represent the order in which individual instructions are executed. Execution may then resume, now non-speculatively, with the now definitively know correct branch direction. Other forms of speculative execution are also known in processors.

One challenge is that, when a branch or microbranch in a microcode subroutine is mispredicted, the values stored in the microcode alias locations disclosed herein may potentially be altered or changed, between the time when they are initially written or specified, and the time the mispredicted microbranch is detected. If the execution is to be rewound, for example by rewound by jumping or branching back in the control flow to the conditional branch that was mispredicted, then the changes or alterations to the values stored in the microcode alias locations may cause these values to be corrupted or invalid for the rewound execution. Similarly, in faults, traps, interrupts, and the like, the values stored in the microcode alias locations disclosed herein may potentially be altered or changed.

Embodiments disclosed herein allow values in microcode alias locations that correspond to parameters passed between a microcode caller and a microcode subroutine to be stored or preserved elsewhere. Further embodiments additionally allow for such values, when or if subsequently needed (e.g., in the event of misprediction of a conditional microbranch) to be restored back to the microcode alias locations. It is to be appreciated that saving and restoring these values is optional and not required. The microcode aliased parameter passing logic previously described may be used either with or without the saving and restoring of these values.

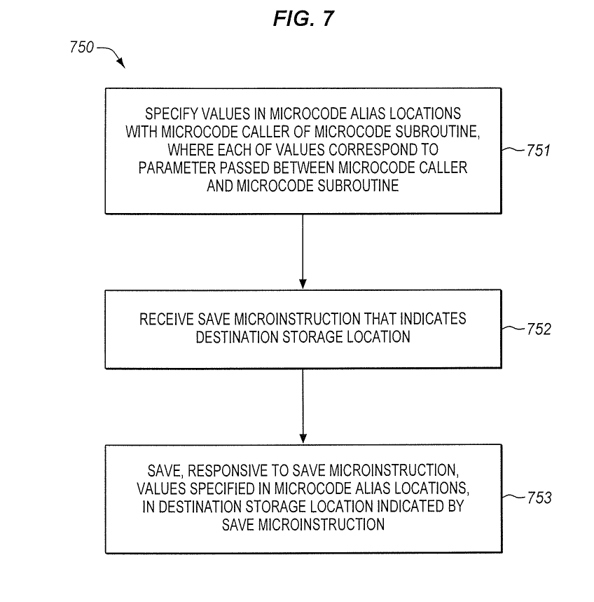

FIG. 7 is a block flow diagram of an embodiment of a method 750 of saving or preserving values from microcode alias locations. In one or more embodiments, the method may be performed by and/or within a processor or other instruction processing apparatus. For example, in one or more embodiments, the method may be performed by and/or within the processor 100 of FIG. 1, or one similar. Alternatively, the method 750 may be performed by and/or within a processor or other instruction processing apparatus entirely different than the processor of FIG. 1.

The method includes specifying a plurality of values in a plurality of microcode alias locations with a microcode caller of a microcode subroutine, where each of the values corresponds to a parameter passed between the microcode caller and the microcode subroutine, at block 751. In one or more embodiments, each of the values may represent a location of a corresponding parameter, such as, for example, a register storing a source data or a register where a result is to be stored, to name just a few examples.

Then, a save microinstruction indicating a destination storage location may be received, at block 752. In one or more embodiments, the save microinstruction may occur in the microcode caller prior to a call to the microcode subroutine, which may have a conditional microbranch instruction. Alternatively, the save microinstruction may occur in the microcode subroutine prior to a conditional microbranch of the subroutine, or prior to corruption of the microcode alias register locations. In one or more embodiments, the destination storage location may be a register, such as a temporary register.

Responsive to the save microinstruction, the plurality of values specified in the plurality of microcode alias locations, may be stored in the destination storage location indicated by the save microinstruction, at block 753. In one or more embodiments, in addition to the values in the microcode alias locations, the save microinstruction is also operable to save a microinstruction pointer in the destination storage location indicated by the save microinstruction. Although the microinstruction has been termed a save microinstruction, it could be implemented with a move microinstruction, a copy microinstruction, a write microinstruction, or other microinstructions that are able to store the values in the destination storage location.

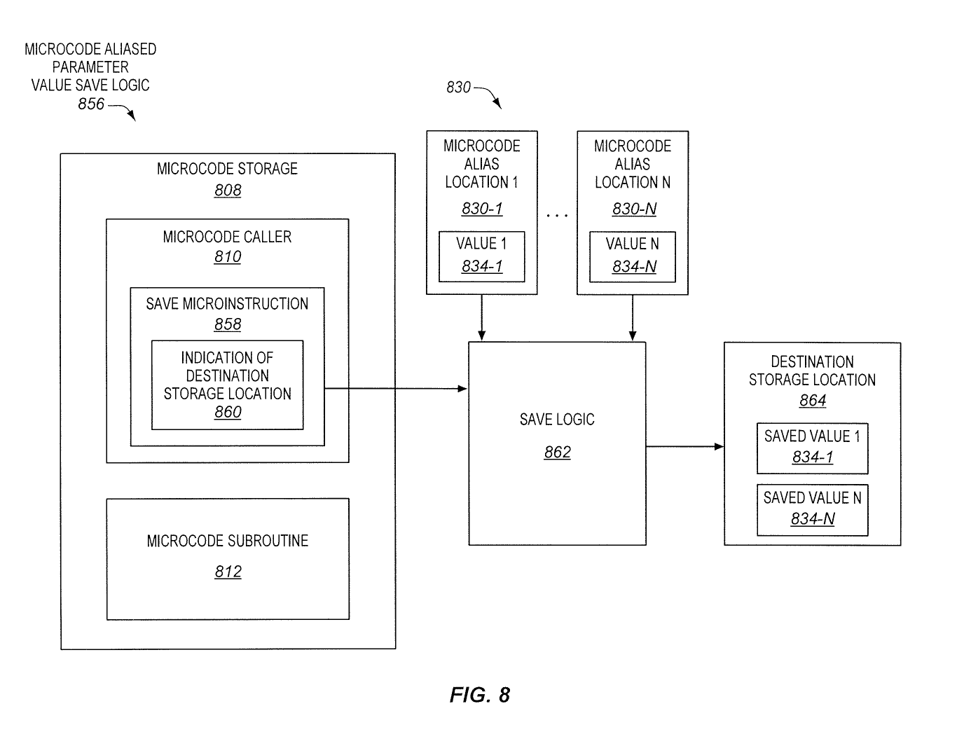

FIG. 8 is a block diagram of an embodiment of microcode aliased parameter value save logic 856. In one or more embodiments, the logic 856 may be included in the processor 100 of FIG. 1, or one similar, or an entirely different instruction processing apparatus. In one or more embodiments, the logic 856 may perform the method of FIG. 7, or one similar. However, it is to be understood that the logic 856 may perform operations and methods different than those shown in FIG. 7. Moreover, the operations or method discussed above for FIG. 7 may be performed by microcode aliased parameter value save logic either the same as, or similar to, or entirely different than, the logic 856.

The aliased parameter value save logic includes a microcode storage 808, a microcode subroutine 812 stored in the microcode storage, a microcode caller 810 of the microcode subroutine stored in the microcode storage, and a plurality of microcode alias locations 830-1 through 830-N. The microcode storage 808, the microcode subroutine 812, the microcode caller 810, and the microcode alias locations 830 may optionally be similar to, or the same as, the correspondingly named components of FIG. 3, 4, or 6. To avoid obscuring the description, all of these similarities will not be unnecessarily repeated, but rather the discussion below will tend to focus on the different and/or additional characteristics of the logic 856 of FIG. 8.

The microcode caller 810 has a save microinstruction 858. The save microinstruction has an indication 860 of a destination storage location 864. The indication 860 may either be implicit to the microinstruction, or the indication 860 may be explicitly specified by the microinstruction (e.g., through a field of bit values). In one or more embodiments, the indication of the destination storage location may be fixed for the particular save microinstruction. In one or more embodiments, the destination storage location 864 may be a register, such as, for example, a 32-bit temporary integer register, to name one specific example.

Each of the microcode alias locations 830 is operable to store, or stores, a value 834-1 through 834-N. In the illustration, a first microcode alias location 830-1 is operable to store, or stores, a first value 834-1 and an Nth microcode alias location 830-N is operable to store, or stores, an Nth value 834-N. Each value may correspond to a parameter passed between the microcode caller and the microcode subroutine, such as in the call and in the return, if there is a return for that particular subroutine. For example, in one or more embodiments, each value may represent a location of the corresponding parameter, such as, for example, a temporary register storing the parameter (e.g., a source data).

The aliased parameter value save logic also includes save logic 862. The save logic may include hardware (e.g., a circuit), software, firmware, or a combination. In one or more embodiments, the save logic may include at least some circuitry. The save logic is coupled with the microcode alias locations 830 to receive the values 834 from the microcode alias locations. The save logic is operable, responsive to the save microinstruction 858, to store or save the values 834 from the microcode alias locations 830 to the destination storage location 864 (e.g., a particular register) indicated by the indication 860 of the save microinstruction 858. As shown in the illustration, the values 834-1 through 834-N may be stored in the destination storage location 864 as a result of the store microinstruction 858. Advantageously, this effectively saves or preserves the values 834 from the microcode alias locations so that the values may subsequently be restored if they are needed (e.g., if a mispredict of a conditional microbranch instruction occurs) even if the microcode alias locations are subsequently overwritten by other microinstructions. Although the microinstruction has been termed a save microinstruction, it could be implemented with a move microinstruction, a copy microinstruction, or other microinstructions that are able to save or store the values in the destination storage location.

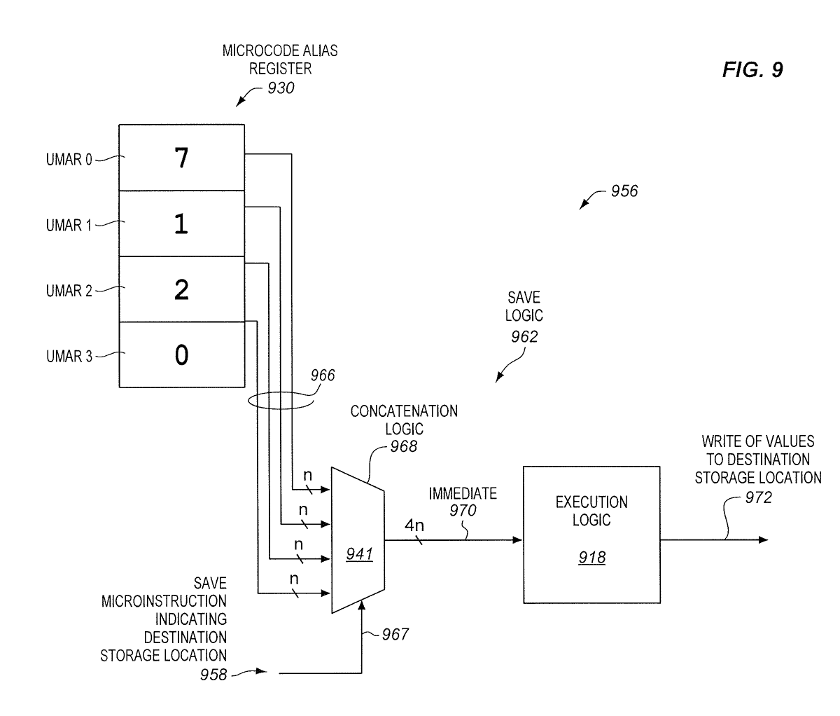

FIG. 9 is a block diagram of an example embodiment of microcode aliased parameter value save logic 956 having a particular example embodiment of a microcode alias register (UMAR) 930 and particular example embodiment of save logic 962. It is to be understood that the example microcode aliased parameter value save logic 956, including the particular microcode alias register 930 and the particular save logic 962, are merely examples and are not required.

The microcode alias register (UMAR) represents one example embodiment of a plurality of microcode alias locations. The UMAR may be similar to, or the same as, the UMAR shown and described above for FIG. 4. As shown in the illustrated example embodiment, the microcode alias register has four microcode alias register locations, in the illustration labeled as UMAR0, UMAR1, UMAR2, and UMAR3, although the scope of the invention is not limited to just four locations. Alternate embodiments may have fewer or more than four locations. Other microcode alias locations such as different registers are also suitable.

Each of the microcode alias register locations has a value. For example, as shown, the integer values 7, 1, 2, and 0 may be stored in the four microcode alias register locations UMAR0, UMAR1, UMAR2, and UMAR3, respectively. These values are only examples. In one or more embodiments, each of these values (i.e., 7, 1, 2, 0) may represent a register number or other location identifier where a different corresponding parameter is stored (e.g., Register7, Register1, Register2, and Register0).

The particular example embodiment of the save logic 962 includes a concatenation logic 968 and an execution logic 918. The concatenation logic is coupled with the plurality of microcode alias register locations. The concatenation logic is coupled to receive as inputs the output of each of the microcode alias register locations. For example, as shown lines or paths 966 may couple outputs of each of UMAR0, UMAR1, UMAR2, and UMAR3 with corresponding inputs to the concatenation logic. The concatenation logic is also coupled by a line or path 967 to receive a control input, such as, for example, a save microinstruction 958 indicating a destination storage location, or a field of the save microinstruction, or a signal derived from or based on the save microinstruction.

The concatenation logic is operable, responsive to the save microinstruction, to concatenate or combine the values or contents received from the microcode alias register according to the control of the control input. For example, in one particular example embodiment, the concatenation logic may combine four separate 4-bit integer values (e.g., 7, 1, 2, 0) from the microcode alias register locations into a single 16-bit integer value having 7120.

In one or more embodiments, the concatenation logic may include a combining multiplexer (MUX) 941 that is operable to concatenate or combines several sets of bits into a combined or concatenated set of bits. The MUX represents one suitable example embodiment of concatenation logic. Alternatively, other bit or field concatenation circuits, logic, or substitutes for the MUX known in the arts, may be used instead of the MUX. The logic 968 may also receive other inputs (not shown) which are not pertinent to this disclosure (e.g., those pertaining to different fields of variable length instructions).

In one or more embodiments, the concatenation logic may concatenate, combine, or multiplex the values in the microcode alias registers into an immediate or constant of the save microinstruction. In such an embodiment, the concatenation logic may represent parameterized immediate alias determination logic for the save microinstruction. The save microinstruction having the combined values as the immediate or constant 970 may then be sent down the pipeline or otherwise provided to the execution logic 918.

As shown, the execution logic is coupled with the output of the concatenation logic to receive the save microinstruction having the immediate 970. The execution logic is operable, responsive to the save microinstruction, to save the values from the immediate in the destination storage location indicated by the save microinstruction. As shown, the execution logic may cause a write, or other save 972 of the values from the immediate or constant to the destination storage location indicated by the microinstruction.

In one or more embodiments, along with the values from the microcode alias locations, the save microinstruction may be further operable to save a microinstruction pointer (e.g., top of a microinstruction pointer stack address) in the destination storage location indicated by the save microinstruction. Just as the values in the microcode alias locations may be altered or corrupted during speculative execution, so may the microinstruction pointer. Accordingly, in one or more embodiments, the save microinstruction may store or preserve both the values in the microcode alias locations as well as the microinstruction pointer in unison. Alternatively, the values in the microcode alias locations and the microinstruction pointer could each be saved with a different microinstruction.

In one or more embodiments, the same microinstruction or flowmarker may be used to write or specify the values in the microcode alias locations as well as save or preserve the values from the microcode alias locations into the destination storage location. For example, the microinstruction 324 in FIG. 3 which writes or specifies the locations 336 in the microcode alias locations 330 and/or the write UMAR microinstruction 424 in FIG. 4 which writes or specifies the locations 436 in the microcode alias register locations 430 may be the same microinstruction as the save microinstruction 858 in FIG. 8 which stores or preserves the values 834 from the microcode alias locations 830 to the destination storage location 864 and/or the save microinstruction 958 of FIG. 9 that writes the values from the microcode alias register 930 to the destination storage location. The locations or values may be written to the microcode alias locations prior to being written or stored to the destination storage location both responsive to the same microinstruction. Alternatively, one microinstruction or flowmarker could write or otherwise specify the values in the microcode alias locations, and another different microinstruction or flowmarker could save the values from the microcode alias locations to the destination storage location.

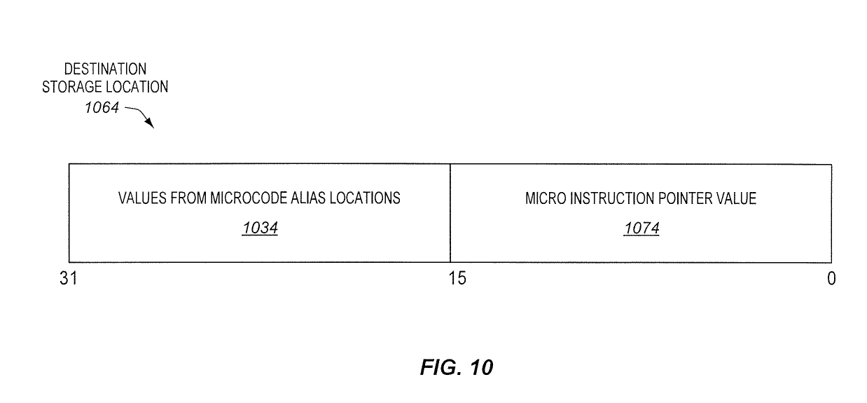

FIG. 10 is a block diagram of a particular example embodiment of a suitable destination storage location 1064. In one or more embodiments, the destination storage location may be a register, such as a temporary integer register, although a temporary integer register is not required. The destination storage location is operable to store, or has stored therein, combined values 1034 from microcode alias locations and a microinstruction pointer value 1074. The particular example embodiment of the destination storage location has 32-bits, where bits 15:0 are used to store the microinstruction pointer value 1074 and bits 31:16 are used to store the values 1034 from microcode alias locations (e.g., 7120), although the scope of the invention is not so limited. This is just one example embodiment of a suitable destination storage location, and the scope of the invention is not limited to this particular example UMAR. In various alternate embodiments, a register with a different number of bits may be used instead, with potentially different numbers of bits for the values and the microinstruction pointer, or the microinstruction pointer need not be stored in the destination storage location along with the values.

In one or more embodiments, if appropriate, such as if execution is to be rewound in the event of a mispredicted conditional microbranch instruction, values or locations may be restored from the destination storage location back to the microcode alias locations or microcode alias register. In one or more embodiments, these values or locations may be restored by a restore microinstruction which indicates the destination storage location. In one or more embodiments, the destination storage location indicated by the restore microinstruction may be the same destination storage location indicated by the save microinstruction. In one or more embodiments, the restore microinstruction may be a microinstruction within a microcode subroutine or sub-subroutine, for example, which occurs after a conditional microbranch instruction of the subroutine is known to have been mispredicted.

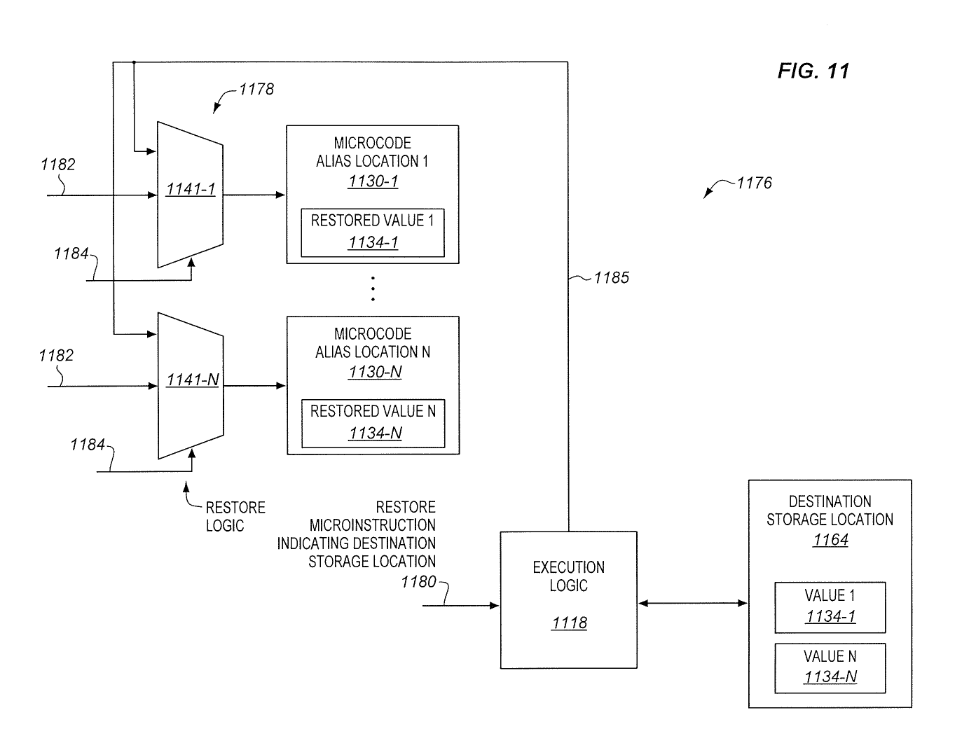

FIG. 11 is a block diagram of an embodiment of microcode aliased parameter value restore logic 1176. In one or more embodiments, the logic 1176 may be included in the processor 100 of FIG. 1, or one similar, or an entirely different instruction processing apparatus.

The microcode aliased parameter value restore logic includes execution logic 1118, a destination storage location 1164, a plurality of microcode alias locations 1130-1 through 1130-N, and restore logic 1178. The microcode alias locations and the destination storage location may optionally be similar to, or the same as, the correspondingly named components in previously described figures. To avoid obscuring the description, all of these similarities will not be unnecessarily repeated, but rather the discussion below will tend to focus on the different and/or additional characteristics of the logic 1176 of FIG. 11.

A restore microinstruction 1180 having an indication of the destination storage location 1164, for example as a source operand, may be provided to the execution logic. The restore microinstruction may either implicitly indicate or explicitly specify the destination storage location. In one aspect, the indication of the destination storage location may be fixed for the particular restore microinstruction. In one aspect, the destination storage location 1164 may be the same destination storage location indicated by the previously described save microinstruction.

The execution logic may execute the restore microinstruction. The execution of the restore microinstruction may cause values 1134-1 through 1134-N to be accessed from the destination storage location 1164 and provided to the restore logic 1178. For example, the values from the destination storage location, for example a temporary register, may be sent back to the front-end of the pipeline to the restore logic.

The restore logic 1178 is operable to write, move, copy, or otherwise store the values to the microcode alias locations as restored values. The restore logic may include hardware (e.g., a circuit), software, firmware, or a combination. In one or more embodiments, the restore logic may include at least some circuitry. Advantageously, this allows the values in the microcode alias locations to be used (e.g., in the event of rewound execution following a mispredict of a conditional microbranch instruction) even if the microcode alias locations were subsequently overwritten/changed by other microinstructions.

In the illustrated embodiment, the restore logic 1178 includes a MUX or other selection device 1141 for each of the microcode alias locations. Each of the MUXs may receive a corresponding restored value at an input thereof. The MUXs may also each be coupled with a write microinstruction of a microinstruction caller or other alternative as mentioned elsewhere herein to receive values over lines 1182 to additional inputs. The MUXs may be operable to select between whether to write the values from the write microinstruction or the restored values based on a control input 1184. The control input may be provided by the microcode (e.g., a microinstruction writing the microcode alias locations), the execution unit (e.g., as a result of a restore microinstruction), or a combination.

The values may be provided to the restore logic 1178 over one or more lines or interconnects 1185. In one or more embodiments, the values may be restored via a bus that carries a branch misprediction address from a jump execution unit, although this is not required.

In one or more embodiments, in addition to restoring the values from the destination storage location to the microcode alias locations, the microinstruction pointer stack may also be restored by the restore microinstruction.

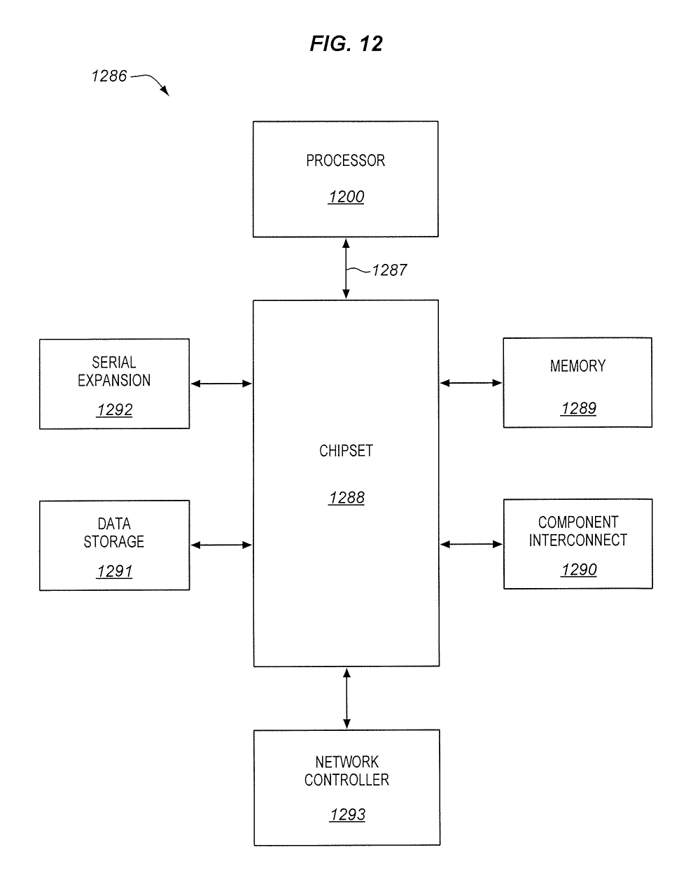

Still other embodiments pertain to a system (e.g., a computer system or other electronic device) having one or more processors as disclosed herein and/or performing a method as disclosed herein. FIG. 12 is a block diagram of an example embodiment of a suitable computer system or electronic device 1286.

The computer system includes a processor 1200. In one or more embodiments, the processor may include microcode aliased parameter passing logic and/or microcode aliased parameter save and restore logic as disclosed elsewhere herein.

The processor may have one or more cores. In the case of a multiple core processor, the multiple cores may be monolithically integrated on a single integrated circuit (IC) chip or die. In one aspect, each core may include at least one execution unit and at least one cache. The processor may also include one or more shared caches.

In one particular embodiment, the processor may include an integrated graphics controller, an integrated video controller, and an integrated memory controller that are each monolithically integrated on a single die of the general-purpose microprocessor, although this is not required. Alternatively, some or all of these components may be located off-processor. For example, the integrated memory controller may be omitted from the processor and the chipset may have a memory controller hub (MCH).

The processor is coupled to a chipset 1288 via a bus (e.g., a front side bus) or other interconnect 1287. The interconnect may be used to transmit data signals between the processor and other components in the system via the chipset.

A memory 1289 is coupled to the chipset. In various embodiments, the memory may include a random access memory (RAM). Dynamic RAM (DRAM) is an example of a type of RAM used in some but not all computer systems.

A component interconnect 1290 is also coupled with the chipset. In one or more embodiments, the component interconnect may include one or more peripheral component interconnect express (PCIe) interfaces. The component interconnect may allow other components to be coupled to the rest of the system through the chipset. One example of such components is a graphics chip or other graphics device, although this is optional and not required.

A data storage 1291 is coupled to the chipset. In various embodiments, the data storage may include a hard disk drive, a floppy disk drive, a CD-ROM device, a flash memory device, a dynamic random access memory (DRAM), or the like, or a combination thereof.

A network controller 1293 is also coupled to the chipset. The network controller may allow the system to be coupled with a network.

A serial expansion port 1292 is also coupled with the chipset. In one or more embodiments, the serial expansion port may include one or more universal serial bus (USB) ports. The serial expansion port may allow various other types of input/output devices to be coupled to the rest of the system through the chipset.

A few illustrative examples of other components that may optionally be coupled with the chipset include, but are not limited to, an audio controller, a wireless transceiver, and a user input device (e.g., a keyboard, mouse).

In one or more embodiments, the computer system may execute a version of the WINDOWS™ operating system, available from Microsoft Corporation of Redmond, Wash. Alternatively, other operating systems, such as, for example, UNIX, Linux, or embedded systems, may be used.

This is just one particular example of a suitable computer system. Other system designs and configurations known in the arts for laptops, desktops, handheld PCs, personal digital assistants, engineering workstations, servers, network devices, network hubs, switches, video game devices, set-top boxes, and various other electronic devices having processors, are also suitable. In some cases, the systems may have multiple processors.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate embodiments of the invention. The scope of the invention is not to be determined by the specific examples provided above but only by the claims below. In other instances, well-known circuits, structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

Various operations and methods have been described. Some of the methods have been described in a basic form in the flow diagrams, but operations may optionally be added to and/or removed from the methods. In addition, while the flow diagrams show a particular order of the operations according to example embodiments, it is to be understood that that particular order is exemplary. Alternate embodiments may optionally perform the operations in different order, combine certain operations, overlap certain operations, etc. Many modifications and adaptations may be made to the methods and are contemplated.

Certain operations may be performed by hardware components, or may be embodied in machine-executable or circuit-executable instructions, that may be used to cause, or at least result in, a circuit or hardware programmed with the instructions performing the operations. The circuit may include a general-purpose or special-purpose processor, or logic circuit, to name just a few examples. The operations may also optionally be performed by a combination of hardware and software. An execution unit and/or a processor may include specific or particular circuitry or other logic responsive to a instructions or microinstructions or one or more control signals derived from a machine instruction to perform certain operations.

One or more embodiments includes an article of manufacture (e.g., a computer program product) that includes a machine-accessible and/or machine-readable medium. The medium may include, a mechanism that provides, for example stores or transmits, information in a form that is accessible and/or readable by the machine. The machine-accessible and/or machine-readable medium may provide, or have stored thereon, one or more or a sequence of instructions and/or data structures that if executed by a machine causes or results in the machine performing, and/or causes the machine to perform, one or more or a portion of the operations or methods or the techniques shown in the figures disclosed herein.

In one embodiment, the machine-readable medium may include a tangible non-transitory machine-readable storage media. For example, the tangible non-transitory machine-readable storage media may include a floppy diskette, an optical storage medium, an optical disk, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, or a combinations thereof. The tangible medium may include one or more solid or tangible physical materials, such as, for example, a semiconductor material, a phase change material, a magnetic material, etc.

In another embodiment, the machine-readable media may include a non-tangible transitory machine-readable communication medium. For example, the transitory machine-readable communication medium may include electrical, optical, acoustical or other forms of propagated signals, such as carrier waves, infrared signals, digital signals, etc.)

Examples of suitable machines include, but are not limited to, computer systems, desktops, laptops, notebooks, netbooks, nettops, Mobile Internet devices (MIDs), network devices, routers, switches, cellular phones, media players, and other electronic devices having one or more processors or other instruction execution devices. Such electronic devices typically include one or more processors coupled with one or more other components, such as one or more storage devices (non-transitory machine-readable storage media), user input/output devices (e.g., a keyboard, a touchscreen, and/or a display), and/or network connections. The coupling of the processors and other components is typically through one or more busses and bridges (also termed bus controllers). Thus, the storage device of a given electronic device may stores code and/or data for execution on the one or more processors of that electronic device. Alternatively, one or more parts of an embodiment of the invention may be implemented using different combinations of software, firmware, and/or hardware.

It should also be appreciated that reference throughout this specification to “one embodiment”, “an embodiment”, or “one or more embodiments”, for example, means that a particular feature may be included in the practice of embodiments of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. An apparatus comprising:
a plurality of microcode alias locations;
a microcode storage;
a microinstruction of a microcode subroutine stored in the microcode storage, the microinstruction having an indication of a microcode alias location;
a microcode caller of the microcode subroutine stored in the microcode storage, the microcode caller operable to specify a location of a parameter in the microcode alias location indicated by the microinstruction; and
parameter location determination logic coupled with the microcode alias locations, and responsive to the microinstruction of the microcode subroutine, to receive the indication of the microcode alias location from the microinstruction, the logic operable to determine the location of the parameter specified in the microcode alias location indicated by the microinstruction.

2. The apparatus of claim 1, wherein the microinstruction of the microcode subroutine implicitly indicates the microcode alias location, and wherein the implicitly indicated microcode alias location is fixed for the microinstruction of the microinstruction subroutine.

3. The apparatus of claim 1, wherein the location of the parameter comprises one of:
a location where a source data is stored;
a location where a result data is to be stored;
a location where an immediate data is stored;
a location where a parameter, specifying a type of an operation of the microinstruction of the microcode subroutine, is stored;
a location where a parameter, specifying a mode in which an operation of the microinstruction of the microcode subroutine is to be performed, is stored; and
a location where a parameter, specifying a mode in which an arithmetic flag is to be used, is stored.

4. The apparatus of claim 3, wherein the location of the parameter comprises one of the location where the source data is stored and the location where the result data is to be stored.

5. The apparatus of claim 1, wherein the microcode caller has at least one of a microinstruction and a flowmarker to write the location of the parameter in the microcode alias location, which comprises a storage location.

6. The apparatus of claim 1, wherein the microcode caller has at least one of a microinstruction and a flowmarker to write the location of the parameter in the microcode alias location, and wherein said at least one of the microinstruction and the flowmarker also writes a microinstruction pointer.

7. The apparatus of claim 1, wherein the plurality of microcode alias locations comprise a plurality of microcode alias register locations in a microcode alias register.

8. The apparatus of claim 1, wherein the plurality of the microcode alias locations comprise a plurality of storage locations, wherein the parameter location determination logic comprises logic coupled to receive a location stored in each of the storage locations and select and output a location for a storage location of the plurality that corresponds to the microcode alias location indicated by the microinstruction.

9. The apparatus of claim 1, wherein the location of the parameter comprises a location in a register, and wherein register is any one of an integer register, a floating point register, a segment register, and a control register.

10. The apparatus of claim 1, implemented in a general-purpose microprocessor.

11. The apparatus of claim 10, wherein the general-purpose microprocessor comprises an integrated graphics controller, an integrated video controller, and an integrated memory controller that are each integrated on a single die of the general-purpose microprocessor.

12. A method comprising:
specifying a location of a parameter in a microcode alias location, in which the microcode alias location is indicated by a microinstruction of the microcode subroutine; and
responsive to the microinstruction of the microcode subroutine, outputting the location of the parameter specified in the microcode alias location indicated by the microinstruction of the microcode subroutine.

13. The method of claim 12, wherein at least one of a microinstruction and a flowmarker of a microcode caller of the microcode subroutine specifies the location of the parameter, and wherein the microinstruction of the microcode subroutine implicitly indicates the microcode alias location, and wherein the implicitly indicated microcode alias location is fixed for the microinstruction of the microinstruction subroutine.

14. The method of claim 12, wherein the location of the parameter comprises one of the location where the source data is stored and the location where the result data is to be stored.

15. The method of claim 12, wherein at least one of a microinstruction and a flowmarker of a microcode caller of the microcode subroutine specifies the location of the parameter, and wherein the microcode caller has at least one of a microinstruction and a flowmarker to write the location of the parameter in the microcode alias location, and wherein said at least one of the microinstruction and the flowmarker also writes a microinstruction pointer.

16. An article of manufacture comprising:
a machine-readable storage media having stored thereon microinstructions that if executed results in a machine performing operations including, specifying a location of a parameter in a microcode alias location; and
indicating the microcode alias location with a second microinstruction of a microcode subroutine that is called by the microcode caller.

17. The article of manufacture of claim 16, wherein the microinstructions include a first microinstruction of a microcode caller to specify the location of the parameter, and wherein the first microinstruction if executed further results in the machine performing operations comprising:
writing a microinstruction pointer.

18. The article of manufacture of claim 16, wherein the second microinstruction if executed further results in the machine performing operations comprising:
outputting the specified location of the parameter from the microcode alias location indicated by the second microinstruction.

19. A system comprising:
an interconnect;
a processor coupled with the interconnect, the processor including:
a plurality of microcode alias locations;
a microinstruction of a microcode subroutine, the microinstruction having an indication of a microcode alias location;
a microcode caller of the microcode subroutine, the microcode caller operable to specify a location of a parameter in the microcode alias location indicated by the microinstruction; and
parameter location determination logic coupled with the microcode alias locations, and responsive to the microinstruction of the microcode subroutine, to receive the indication of the microcode alias location from the microinstruction, the logic operable to determine the location of the parameter specified in the microcode alias location indicated by the microinstruction; and
a dynamic random access memory (DRAM) coupled with the interconnect.

20. The system of claim 19, wherein the location of the parameter comprises one of the location where the source data is stored and the location where the result data is to be stored.

21. The system of claim 19, wherein the microinstruction of the microcode subroutine implicitly indicates the microcode alias location, and wherein the implicitly indicated microcode alias location is fixed for the microinstruction of the microinstruction subroutine.
